(19) United States
(12) Patent Application Publication
(10) Pub. No.: US 2005/0287427 A1
(43) Pub. Date: Dec. 29, 2005

(54) Battery module

(76) Inventors: Jae-Kyung Kim, Suwon-si (KR); Sang-Eun Cheon, Suwon-si (KR); Seok-Yoon Yoo, Suwon-si (KR); Hye-Won Yoon, Suwon-si (KR)

Correspondence Address: MCGUIREWOODS, LLP, 1750 TYSONS BLVD, SUITE 1800, MCLEAN, VA, 22102, US

(21) Appl. No.: 11/158,097

(22) Filed: Jun. 22, 2005

(30) Foreign Application Priority Data
Jun. 23, 2004 (KR) 10-2004-0047017

(51) Int. Cl. H01M 2/24; H01M 2/02

(52) U.S. Cl. 429/158; 429/164; 429/176

(57) ABSTRACT

A battery module including a plurality of battery cells, wherein the terminal of a positive electrode and the terminal of a negative electrode of the battery cells are coupled through a connection member that includes holes is disclosed.

### CROSS REFERENCE TO RELATED APPLICATION

This application claims priority to and the benefit of Korean Patent Application No. 10-2004-0047017 filed on Jun. 23, 2004, which is hereby incorporated by reference for all purpose as if fully set forth herein.

### BACKGROUND OF THE INVENTION

1. Field of the Invention

The present invention relates to a battery module with an improved connecting structure between high power rechargeable batteries.

2. Description of the Related Art

Generally, a rechargeable battery is classified into a low capacity rechargeable battery or a “battery cell” in which one or several rechargeable unit cells are packaged into a pack shape, or a high capacity rechargeable battery or a “battery module” in which several tens of battery cells are assembled depending upon the desired usage and battery capacity. Battery cells are mainly used as power sources for various portable electronic devices such as cellular phones, laptop computers, and camcorders, while battery modules are used as the power source for driving motors such as in a hybrid automobile.

The rechargeable battery generally has a cylindrical or rectangular box shape and comprises an electrode assembly (or a jelly roll) including a positive electrode and a negative electrode with an insulator separator interposed therebetween that are wound together and inserted into a case.

The positive electrode and the negative electrode are attached by welding to a lead, which is a conductive tab for collecting the current that is generated from the electrodes during operation of the battery. The leads transfer the current that is generated from the positive electrode and negative electrode to the positive electrode and negative electrode terminals, respectively.

When a rechargeable battery is applied to a battery module by itself, it cannot satisfy the capacity and power requirements for the battery module. Japanese Patent Laid Open No. 2003-7346 discloses a rechargeable battery that has a multi-tab structure where a plurality of tabs are attached to the electrode assembly. In this rechargeable battery, a plurality of tabs are formed along a certain direction of the electrode assembly to connect an inner end to an outer end.

A current collector plate structure is suggested as an alternative to the tab structure. Since the current collector plate improves the collection of current by increasing the contact area between itself and the electrode element and decreasing the contact resistance, it has recently been applied to rechargeable cells for a battery module.

The battery module having the above-mentioned structure is typically formed as a rectangular box. The battery module is made by coupling together a plurality of battery cells. The connection is provided by bolting electrode terminals of one battery cell to an adjacent cell and having the terminals protrude from the case.

A cylindrical battery module cannot connect cells through the same structure as used in a rectangular box shaped battery module. Instead, a battery module has adjacent battery cells that are connected by resistance welding using a connection member.

However, considering the operation of the battery module in which high power and high capacity are required, the connection member is designed to have a wider width and a larger cross-sectional area to minimize the resistance characteristics.

When the connection member is attached to the battery cell, the members are not coupled by welding because of the thickness of the connection member. Particularly, these problems are often caused in resistance welding where the contacting area is melted using a large current.

### SUMMARY OF THE INVENTION

The present invention provides a battery module in which coupling between the battery cells is more secure.

Additional features of the invention will be set forth in the description which follows, and in part will be apparent from the description, or may be learned by practice of the invention.

The present invention discloses a battery module comprising a plurality of battery cells in the form of a pack. Terminals of a positive electrode and a negative electrode of the battery cells are coupled with connection members that include holes.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a cross-sectional view of a battery cell according to an exemplary embodiment of the present invention.

FIG. 2 is a perspective view of the battery cell shown in FIG. 1.

FIG. 3 is a partial perspective view of a battery module according to an exemplary embodiment of the present invention.

FIG. 4 is a perspective view of the connection member according to an exemplary embodiment of the present invention.

FIG. 5 is a view of the weld state of the end of a battery cell and the connection member of the rechargeable cell.

FIG. 6 is a view of the resistance welding using the connection member according to an exemplary embodiment of the present invention.

### DETAILED DESCRIPTION OF THE ILLUSTRATED EMBODIMENTS

The present invention relates to a battery module that includes a plurality of battery cells that are coupled with each other to provide a pack system. The battery module of the present invention can decrease the contact resistance and fix the cells together more securely. Thus, the battery module of the present invention improves the operating characteristics by increasing the coefficient for collecting the current.

In the battery module of the present invention, terminals of a positive electrode and a negative electrode of the battery cells are coupled together with a connection member that includes holes. The holes may be present at both ends and are formed through the connection member to prevent transmission of electric current. Preferably, the hole is a cutout hole that is capable of completely interrupting the current. More preferably, the hole may be formed into a slot. In addition, the hole includes an insulating material.

The terminals are coupled with the connection member, and preferably, the terminals and the connection member are connected by resistance welding with the insulator interposed in between them. In this case, terminals of the positive electrode and the negative electrode of the battery cells are alternately arranged in opposing directions and a pair of adjacent battery cells are connected by the connection member.

The connection member may be shorter than the total length of a pair of adjacent battery cells and longer than the distance between the terminals. The insulating portion is preferably formed in a direction perpendicular to the length direction of the connection member. The connection member is preferably formed in a rectangular shape with a length longer than the width. The battery cell preferably has a cylindrical or rectangular box shape.

The battery module may be used to drive a motor for hybrid electric vehicles (HEV), electric vehicles (EV), wireless appliances, motorbikes, and motor scooters which require high power performance.

Hereinafter, preferred embodiments of the present invention are described in detail with reference to the accompany drawings such that a person having ordinary skill in the art may carry out the present invention. Although the examples are described only for an insulator part that is a cutout hole, the present invention is not limited thereto and can apply to a variety of shapes.

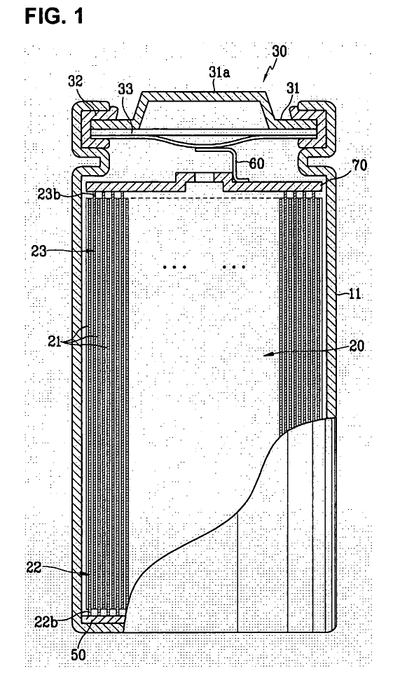

FIG. 1 is a cross-sectional view of the battery cell according to an exemplary embodiment of the present invention.

The battery cell of the present invention may have a cylindrical or hexahedral shape with an electrode assembly 20 including a positive electrode 23 and a negative electrode 22 with an insulator separator 21 interposed therebetween. The electrode assembly 20 is wound and inserted into a open case 11 with a gasket 32, and the open part is sealed with a cap assembly 30.

The case 11 may comprise a conductive material such as aluminum or an aluminum alloy, or steel plated with nickel, for example. The case preferably has a cylindrical shape with a space to accommodate the electrode assembly 20, but it is not limited thereto.

Positive electrode current collector plate 70 and negative electrode current collector plate 50 are coated with a positive active material and a negative active material, respectively to provide a positive electrode 23 and a negative electrode 22, respectively, which are wound as a jelly roll with a separator to provide an electrode element. Uncoated regions 22b and 23b are formed at each end of the positive electrode 23 and the negative electrode 22, respectively. The uncoated regions 22b and 23b are not coated with the respective active materials. The uncoated region 23b of the positive electrode protrudes from the upper part of the electrode element and uncoated region 22b of the negative electrode protrudes from the bottom of the electrode element.

The current collector plate 70 of the positive electrode is coupled with the uncoated region 23b on the upper part of the electrode element, and the current collector plate 50 of the negative electrode is coupled with the uncoated region 22b on the lower part of the electrode element.

The cap assembly 30 comprises a cap plate 31 with an outside end 31a, and the gasket 32. It may further comprise a safety vent (not shown) which is released under a predetermined pressure to prevent explosion of the battery. The gasket 32 is an insulating material which seals the case 11, thereby insulating the cap assembly 30 from the case 11. The cap assembly 30 is coupled with the electrode assembly 20 by the lead line 60.

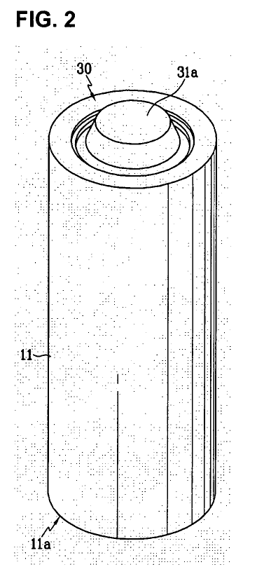

As described above, the rechargeable battery cell of the present invention comprises an electrode assembly 20 inside a case. The current collector plate 50 of the negative electrode which is coupled with the negative electrode 22 is coupled with the bottom surface of the case 11 by resistance welding. Thus, as shown in FIG. 2, the bottom surface of the case 11 forms an end 11a of the negative electrode. Further, a cap assembly 30 is formed on the open part of the case and the current collector 70 of the positive electrode is coupled with the cap assembly 30 by a lead line 60. Thus, the cap assembly 30 is a positive electrode of the cell.

Hereinafter, a battery module comprising battery cells with a cylindrical shape will be described, but the present invention is not limited thereto.

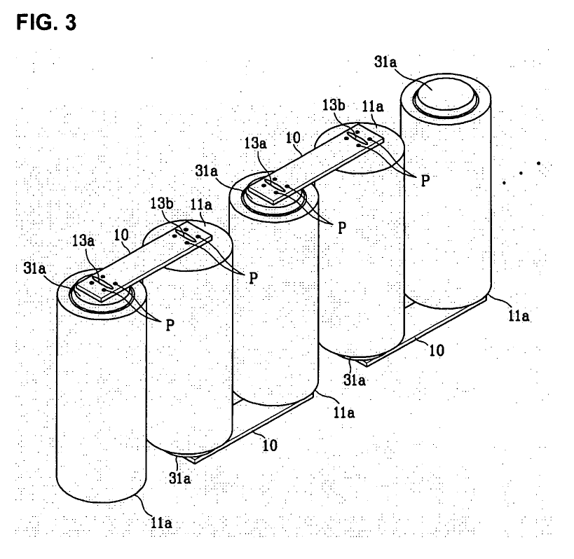

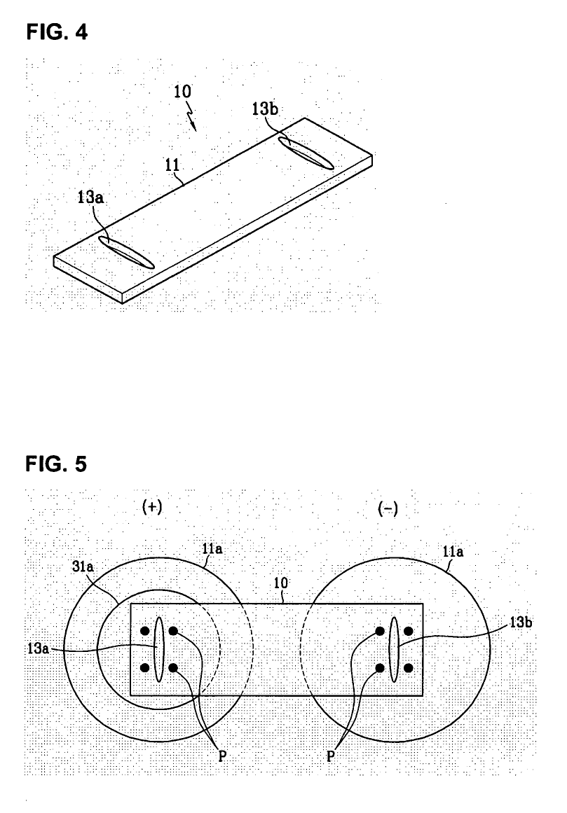

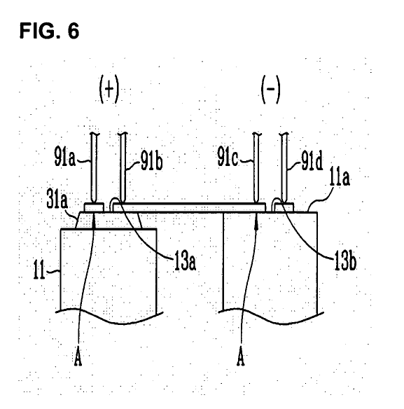

The embodiment is described below with reference to FIG. 3, FIG. 4, FIG. 5 and FIG. 6. As shown in FIG. 3, the battery module of an exemplary embodiment of the present invention includes a plurality of battery cells in which terminals of positive electrodes and negative electrodes are alternatively arranged in opposing directions. Each pair of adjacent rechargeable batteries is coupled with a connection member 10.

That is, the terminal 31a of the positive electrode and the terminal 11a of the negative electrode are alternatively arranged in opposing directions. A plurality of adjacent cells are similarly assembled. Accordingly, the terminal 31a of the positive electrode and the terminal 11a of the negative electrode are alternatively arranged in a first direction and a second direction opposite to the first direction, respectively. In this case, a certain distance is preferably maintained between the cells. Since the battery case is the terminal of the negative electrode, a short circuit may occur if the cells contact each other.

For example, a terminal 31a of the positive electrode of a battery cell is coupled with the terminal 11a of the negative electrode of a first adjacent battery cell by a connection member 10 in a first direction. Then the terminal 31a of the positive electrode of the adjacent battery cell is coupled to the terminal 11a of a second adjacent battery cell by the connection member 10 in the second direction opposite to the first direction to provide a battery module.

Although the above description pertains to battery cells that are connected in series, the battery cells may be optionally connected in a row.

The connection member 10 fixes the terminal 11a of the positive electrode and terminal 31a of the negative electrode by resistance welding. As shown in FIG. 4, the connection member 10 preferably comprises a material that has good electrical conductivity and a hexahedral shape that has increased the cross-sectional area and the width in order to decrease the resistance. Thereby, the connection member 10 has a rectangular shape with a longer length and a shorter width. Both ends along the length direction may be formed with long cutout holes 13a and 13b in the width direction. The cutout holes 13a and 13b are preferably shaped into a slot.

The cutout holes 13a and 13b make up the weak points of the resistance welding due to the thickness of the connection member 10. That is, when the connection member is excessively thick, the current is transmitted to the welding bars 91a, 91b, 91c, and 91d through the connection member before reaching the terminal. Accordingly, the contact surface between the connection member 10 and the terminal is not welded. The cutout holes 13a and 13b prevent transmission of the current to solve the above-mentioned problems.

FIG. 5 and FIG. 6 show welding patterns that use the above-mentioned cutout holes. Pairs of welding bars 91a, 91b, 91c, and 91d are placed on the welding points P with cutout holes 13a and 13b between them. In addition, the connection member 10 is provided with a large current to prevent transmission of the current in the connection member due to the cutout holes 13a and 13b, and to send it to the adjacent welding bar via the terminal. Thus, the contacting surface A melts to be welded. Accordingly, the connection member 10 is more firmly coupled with the terminals 11a and 31a of the electrode by a process such as resistance welding.

The shape of the connection member 10 is designed to minimize resistance, and therefore the cross-sectional area and the width are increased to improve the operating performance of the battery module.

On the other hand, the connection member 10 is preferably shorter than the total length L1 of a pair of adjacent cells and longer than the length L2 between the ends. If the length of the connection member 10 is more than L1, the adjacent cells become connected, causing a short. If the length of the connection member 10 is less than L2, the welding point P, which is required to connect the ends, can not be secured.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A battery module, comprising:
a plurality of battery cells that comprise a positive electrode and a negative electrode,
wherein terminals of the positive electrode and the negative electrode of the battery cells are coupled with a connection member comprising holes.

2. The battery module according to claim 1,
wherein the hole is a cutout hole.

3. The battery module of claim 1,
wherein the terminal is coupled with the connection member by resistance welding.

4. The battery module of claim 1,
wherein the connection member is shorter than the total length of a pair of adjacent rechargeable cells and longer than the distance between the terminals.

5. The battery module according to claim 1,
wherein the terminal of the positive electrode and the terminal of the negative electrode of the battery cells are alternatively arranged in opposing directions and a pair of adjacent battery cells are connected by the connection member.

6. The battery module according to claim 1,
wherein the hole is preferably formed in a direction perpendicular to the length direction of the connection member.

7. The battery module according to claim 2,
wherein the cutout hole is formed as a slot.

8. The battery module according to claim 1,
wherein the connection member has a rectangular shape with a longer axis along the length direction.

9. The battery module according to claim 1,
wherein an insulating material is present in the holes.

10. The battery module according to claim 1,
wherein the battery cell has a cylindrical or rectangular box shape.

11. The battery module according to claim 1,
wherein the battery module is used to drive a motor.
